(19) United States
(12) Patent Application Publication
(10) Pub. No.: US 2025/0116919 A1
(43) Pub. Date: Apr. 10, 2025

(54) DEVICE FOR ASSISTING A DRIVER

(71) Applicant: Flextronics AP, LLC, San Jose, CA (US)

(72) Inventors: MARCO DE ANGELI, BARZANA (IT); ALICE PEREGO, VILLASANTA MB (IT)

(73) Assignee: Flextronics AP, LLC, SAN JOSE, CA (US)

(21) Appl. No.: 18/377,152

(22) Filed: Oct. 5, 2023

(51) Int. Cl. G03B 21/20; B60K 35/00; G02B 27/30

(52) U.S. Cl. CPC G03B 21/2033; B60K 35/00; G02B 27/30; B60K 35/28; B60K 2360/164; B60K 2360/333; B60K 2360/334

(57) ABSTRACT

An information projection device includes a controller and a laser diode operatively coupled with the controller. At least one diffraction optical element is disposed to receive a beam of light from the laser diode and project the beam to a target area. This provides a user with information to assist the user in making decisions regarding to avoid potential hazards.

### BACKGROUND

Providing drivers with information regarding their surroundings and vehicle is useful to assist a user in making decisions regarding potential issues and obstacles. Conventional assistance devices and systems typically utilize fixed frame projection systems and/or complex and expensive liquid crystal display (LCD) based projectors for dynamic content.

### BRIEF DESCRIPTION OF THE DRAWINGS

A more detailed understanding can be had from the following description, given by way of example in conjunction with the accompanying drawings wherein:

FIG. 1 is a schematic diagram of a driver assistance device in accordance with an embodiment;

FIG. 2 is an exploded schematic view of a portion of the driver assistance device of FIG. 1;

FIG. 3A is a series of example display icons for projection by the driver assistance device of FIG. 1;

FIG. 3B is a series of animated display icons for projection by the driver assistance device of FIG. 1;

FIG. 4 shows an example driver assistance system projecting a display icon on the ground next to a vehicle in accordance with an example embodiment; and

FIG. 5 shows an example driver assistance system projecting a display icon onto an A-pillar in a vehicle in accordance with an example embodiment.

### DETAILED DESCRIPTION

Providing drivers with information regarding their surroundings and vehicle is useful to assist a user in making decisions regarding potential issues and obstacles. Conventional assistance devices and systems utilize fixed frame projection systems and/or complex and expensive liquid crystal display (LCD) based projectors for dynamic content.

Although more detail is provided below, described herein is a dynamic projector. The terms “Dynamic Projector” and “Information Projection Device” and “Driver Assistance Device” may be used interchangeably in reference to the present invention. The dynamic projector may be integrated into a vehicle. For example, the dynamic projector may be integrated into an overhead console, a seat, or side mirrors of the vehicle.

In an embodiment, the dynamic projector includes a micro-projector engine that may project onto an A-pillar of a vehicle or any other surface. The projection may advise a driver of specific situations. For example, the driver may be warned of a pedestrian crossing, a low fuel warning, or a baby being left in the back seat. However, additional warnings not specifically described herein may also be provided to the driver. The driver can see the information being projected without needing to take his or her eyes off the road.

The information displayed to the driver may be managed by a central control unit of the vehicle. The central control unit may receive signals from sensors within and outside of the vehicle and communicate this information to the dynamic projector via a digital bus, such as a LIN or CAN bus. In another embodiment, the central control unit may communicate information to the dynamic projector via Bluetooth connection.

A driver assistance device includes a controller and a laser diode operatively coupled with the controller. At least one diffraction optical element is disposed to receive a beam of light from the laser diode and project the beam to a target area.

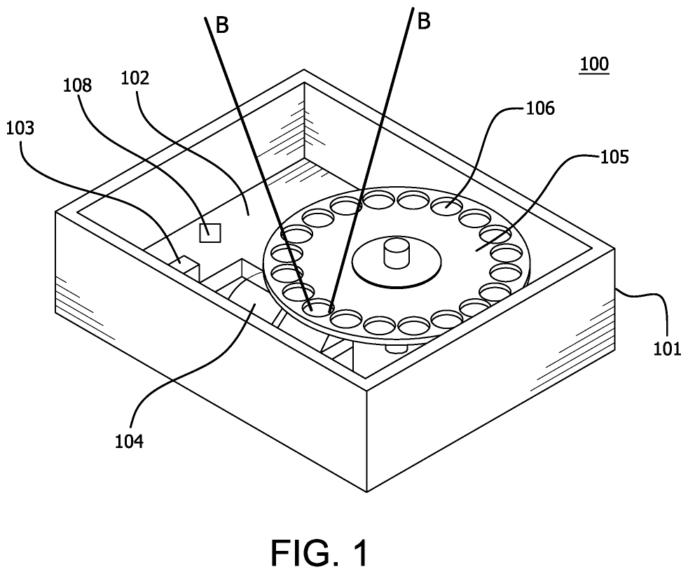

FIG. 1 is a schematic diagram of a driver assistance device 100 in accordance with an embodiment. The driver assistance device 100 may also be referred to as a dynamic projector. The driver assistance device 100 includes a housing 101, which may be mounted in a vehicle.

The housing 101 includes a printed circuit board (PCB) 102, a laser diode 103, a beam collimator 104 and a plurality of diffractive optical elements (DOEs) 106 on a wheel 105. Beams (B) are generated through the DOEs 106 to display an image. Additionally, the housing 101 may include a stator (not shown) that may comprise PCB traces (discussed in greater detail below). Additionally, an electronically controlled micromotor (not shown) may be included to control movement of the wheel 105.

The PCB 102 includes control circuitry 108 (e.g., a controller), such as a processor, memory and other circuitry that may be programmable to control the driver assistance device 100 to display desired messages, which may be in the form of icons, text, or graphics for example. The control circuitry 108 may be communicably coupled to a central control unit (not shown) of the vehicle that receives information from within and outside of the automobile and communicates the information to the control circuitry 108 via a digital bus. As mentioned above, PCB traces may operate as a stator of a motor to select specific DOEs 106 on the wheel 105 by moving the wheel 105. The position of the wheel 105 may be determined by use of a sensor (e.g., optical or magnetic, not shown) to identify the position of the wheel 105 for detecting positions of the DOEs 106. The laser diode 103 emits a beam B for which the beam collimator 104 collimates into a parallel beam (e.g., beam B). An additional sensor (not shown) may be included to determine a distance from the beam B being emitted in order to prevent the beam B from being focused into a person's eye. If the distance is too close to an intervening person, the beam B may cut off for safety.

The beam B may then be emitted through the DOEs 106 to project an image to a target area. The beam B may be controlled to form the various images desired to provide information to a driver. Some example images are described below.

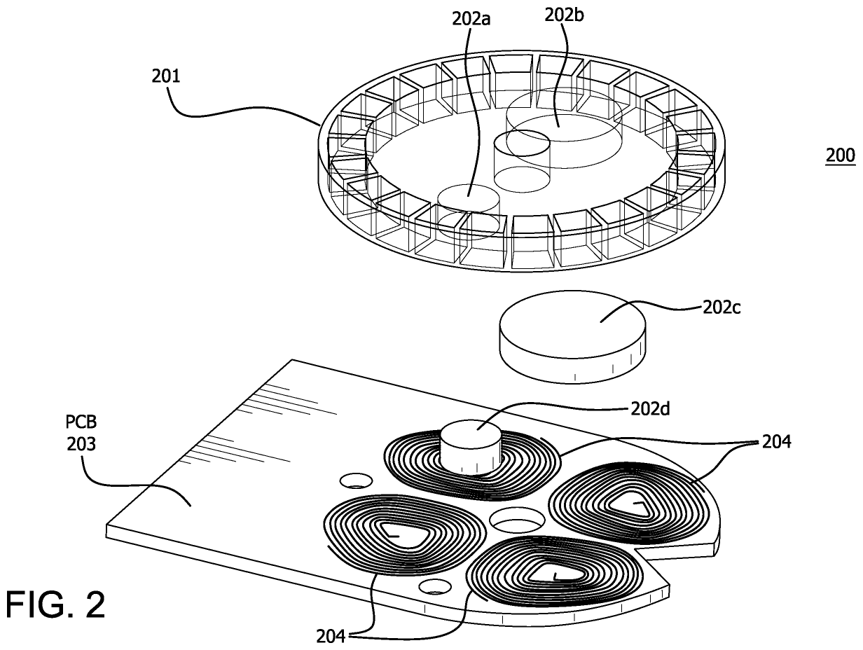

FIG. 2 is an exploded schematic view of a portion 200 of the driver assistance device 100 of FIG. 1. As shown in FIG. 2, a magnet shell/projector disk 201 is included that may contain the DOEs 106.

Magnets 202 are provided on the disk 201 in order to allow the disk 201 to be moved and operated. The PCB 203 includes corresponding magnetic coils 204 which may be utilized to control the magnets 202 in order to rotate the disk 201. By controlling the portion of the magnets 202 utilizing the magnetic coils 204, the rotation of the disk 201 can project various images with the beams B. In addition, images may be “animated”, such as having an animated text scrolling or waving, for example, by using a plurality of successive images. The wheel 105 includes magnets 202 to create a rotor, and may be paired with magnetic coils 204 as a stator. Alternatively, the wheel 105 may comprise two separate disks 201 glued or bound together, one holding the magnets 202, the other with the DOEs 106. Another alternative may be to utilize a micromotor, and a plastic wheel with the DOEs 106, without utilizing magnets 202 for propulsion. A small magnet 202 or a reflective line may be added to inform the electronics of the position of the wheel 105 while in rotation. A magnetic hall sensor or an optical reflectance sensor may also be included on the PCB 203 to determine the location of the wheel 105.

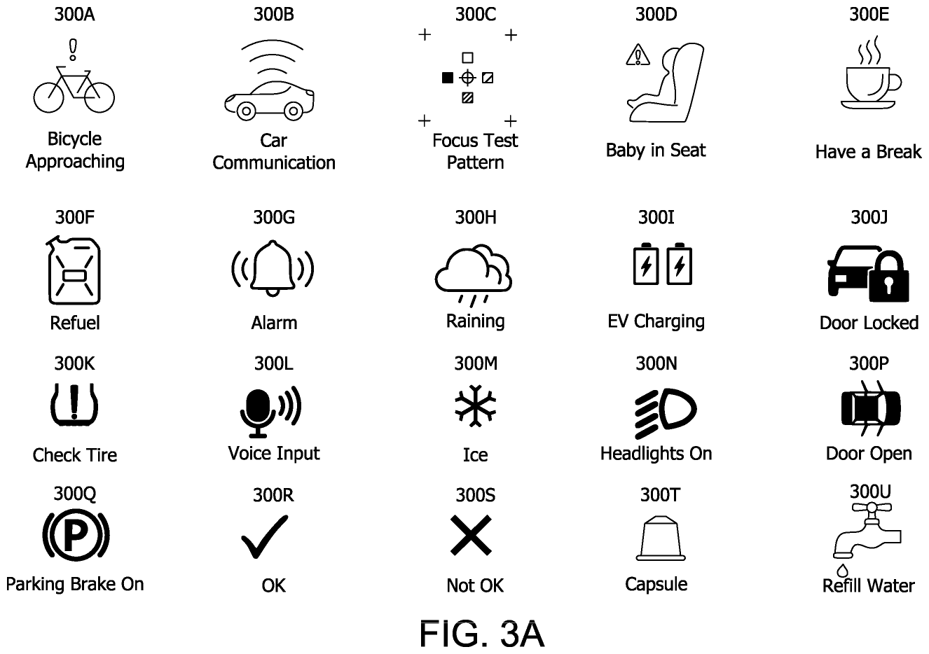

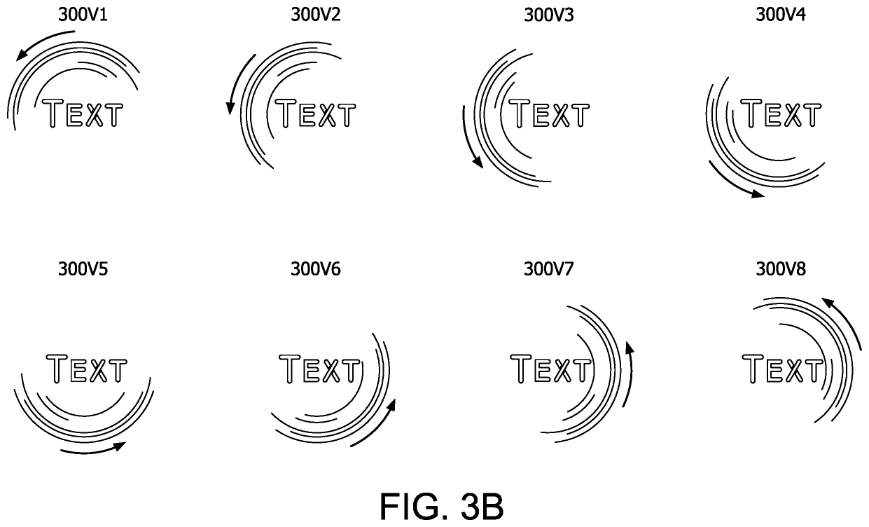

FIG. 3A shows a plurality of example display icons 300A-300U for projection by the driver assistance device 100 of FIG. 1. For example, display icon 300A may show a potential bicycle in the path of the driver. Display icon 300B may show a vehicle obstacle. Display icon 300C may include focus test driving. Display icon 300D may remind the driver a baby is in the seat. Display icon 300E may remind the driver that he or she should take a break from driving. Display icon 300F may alert the driver to refuel.

Display icon 300G may alert the driver to an alarm. Display icon 300H may alert the driver it is raining. Display icon 300I may alert the driver to EV charging. Display icon 300J may alert the driver a door or doors are locked. Display icon 300K may alert the driver to a tire pressure issue. Display icon 300L may alert the driver to a voice input.

Display icon 300M may alert the driver to icy conditions. Display icon 300N may alert the driver that headlights are on. Display icon 300P may alert the driver a door is open. Display icon 300Q may alert the driver the parking brake is on. Display icon 300R may alert the driver to an OK condition. Display icon 300S may alert the driver to a not OK condition. Display icon 300T may alert the driver to a capsule. Display icon 300U may alert the driver to refill water.

Although FIG. 3A shows various example icons, it is understood that any information, including graphics or text may be displayed to the driver by the driver assistance device 100.

FIG. 3B is a series of animated display icons 300V1-300V8 for projection by the driver assistance device 100 of FIG. 1. In the example shown in FIG. 3B, each of the icons 300V1-300V8 includes a text portion and a series of arcs around the text portion. As each icon image is projected, the image of the arcs appears to rotate around the text. That is, as 300V1 proceeds to 300V2, 300V2 proceeds to 300V3, 300V3 proceeds to 300V4, 300V4 proceeds to 300V5, 300V5 proceeds to 300V6, 300V6 proceeds to 300V7, 300V7 proceeds to 300V8, and 300V8 proceeds back to 300V1, the arcs appear to animate around the text.

Although the example shown in FIG. 3B utilizes arcs rotating around stationary text, any type of animation can be shown using the technique described in FIG. 3B. For example, the text may change in each icon V1-V8, so that the message may appear to be a dynamically changing message.

As mentioned hereinbefore, the images or text displayed by the driver assistance device 100 may be projected in an area easily observable by the driver, but so as to not distract the driver from operating the vehicle.

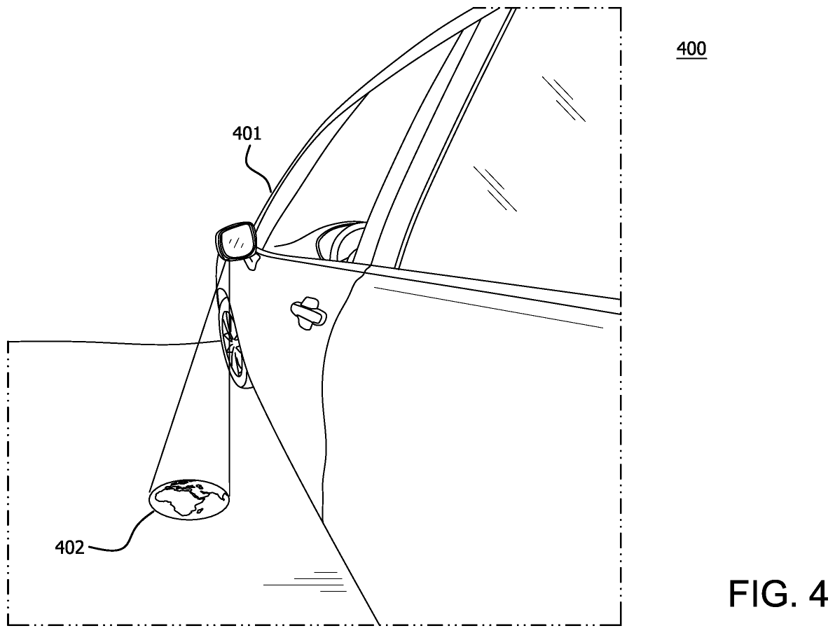

FIG. 4 shows an example driver assistance system 400 projecting a display icon on the ground next to a vehicle 401 in accordance with an example embodiment. As shown in FIG. 4, a vehicle 401 is controlled by the driver. The image 402 is projected, in this case, on the ground next to the driver. For example, the image 402 may alert the driver as to how close to a curb or a parking line the driver is. Additional projections may include a logo of the car brand, a reminder to a driver (such as leaving keys or another item in the car) before locking the vehicle.

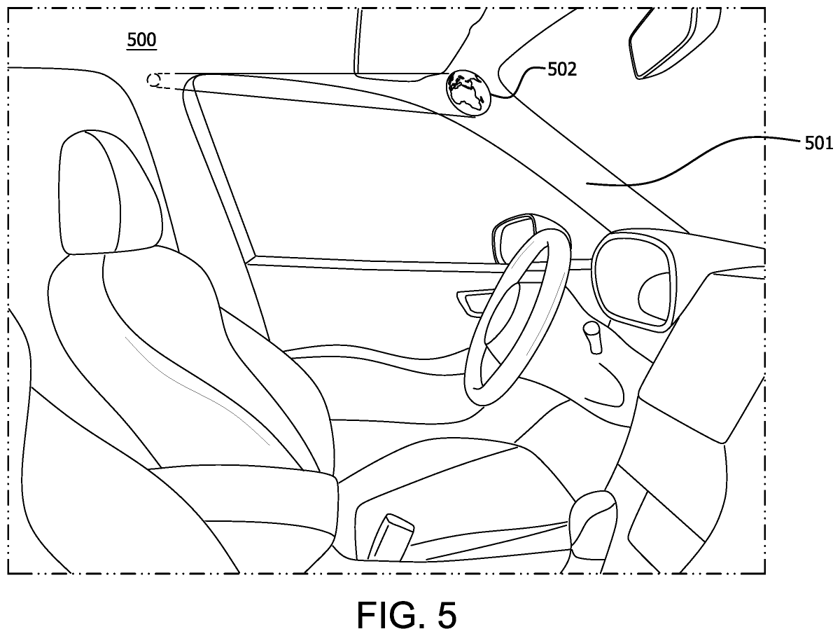

FIG. 5 shows an example driver assistance system 500 projecting a display icon onto an A-pillar 501 in a vehicle in accordance with an example embodiment. Similar to the example driver assistance system 400, the example driver assistance system 500 projects an image 502 of a display icon. In this case the image 502 is displayed on the A-pillar 501 of the vehicle. The image 502 may be any one of the display icons 300A-300U discussed above in FIG. 3A. In addition, the image 502 could be map information, such as global positioning system (GPS) information to advise the driver of an upcoming turn, exit, or the like.

As discussed previously, the images may be stationary or may be animated to provided enhanced information to the driver.

It should be understood that although the control circuitry 108 controls which of the plurality of DOEs 106 to project, the control circuitry 108 receives input from the automobile, or from a mobile device of a driver. For example, the automobile may have a central control unit that transmits information via digital bus or Bluetooth connection to the control circuitry 108. This information may include sensor information, performance information regarding the automobile's engine or electrical systems, or any other information that is available. Likewise, information from a mobile device of a user may be communicated to the control circuitry 108 via a Bluetooth connection.

It should be understood that many variations are possible based on the disclosure herein. Although features and elements are described above in particular combinations, each feature or element can be used alone without the other features and elements, or in various combinations with or without other features and elements.

For example, the laser may only activate the projection of a single icon of the plurality of DOEs 106 without utilizing a rotating disk and/or motor. Additionally, multiple lasers may be provided in order to project an icon selected from a pool of limited icons. For example, if only 4 icons are utilized, 4 lasers may each be paired with its own DOE, instead of rotating a wheel over a single laser.

The wheel may also accommodate DOEs in a circular fashion, at a fixed radius, but additionally “optical traces” like in a CDROM could be utilized. By steering the beam to different radii a different trace may be selected, increasing the number of DOE elements selectable and carried on a single wheel.

A heatsink may be provided on the back of the module, to release thermal energy from the laser and from the motor, and a distance sensor may be utilized to improve the safety of the device in case an object intervenes with the device and the projection location of the laser.

Focal adjustment and lens positioning may be performed utilizing a test pattern implemented during, for example, manufacturing.

A controller area network/local interconnect network (CAN/LIN) interface may be in communication with the controller to control the device from an automotive CAN/LIN bus.

Additionally, the driver assistance device may be paired with a special screen (e.g., made of microbeads). The A pillar or any other surface may be treated to improve the visibility of the projected icons to the direction of the driver's head.

Additional lasers may be used to create colorful patterns where desired. Although the above device and system are described with respect to an automotive application, the device/system may be employed outside a vehicle application. For example, the projector (i.e., assistance device) may be integrated into a coffee machine and project on the wall an icon such as ‘capsule missing’, ‘refill water’ and the like. Another application may be to employ the device in a cook stove, where an image is projected (e.g., on a back-splash wall, etc.) to highlight a hot temperature warning, a timer expired, and/or other information.

The methods provided can be implemented in a computer program, software, or firmware incorporated in a non-transitory computer-readable storage medium for execution by a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. An information projection device, comprising:
a controller;
a laser diode operatively coupled with the controller; and
at least one diffraction optical element disposed to receive a beam of light from the laser diode and project the beam to a target area.

2. The information projection device of claim 1, further comprising a wheel, wherein the at least on diffraction optical element is situated on the wheel.

3. The information projection device of claim 2, wherein a plurality of diffraction optical elements are situated about a periphery of the wheel.

4. The information projection device of claim 3, wherein the wheel further comprises at least one element for locating a position on the wheel.

5. The information projection device of claim 2, wherein the wheel further comprises at least one magnetic element.

6. The information projection device of claim 5, further comprising a control board that comprises at least one magnetic element, the magnetic element for energizing and cooperation with the at least one magnetic element on the wheel for rotating the wheel.

7. The information projection device of claim 1, wherein the at least one diffraction optical element includes information relating to operation of a vehicle.

8. The information projection device of claim 7, wherein each of a plurality of diffraction optical elements includes a sequence element of a plurality of sequences of elements such that upon the display of the sequence of elements an animated information is displayed.

9. The information projection device of claim 8, further comprising a motor operatively coupled with the wheel and the controller, the motor configured to rotate the wheel.

10. The information projection device of claim 1, further comprising a beam collimator disposed between the diffraction optical elements and the laser diode, configured to collimate the laser through at least one of the diffraction optical elements.
